(19) United States
(12) Patent Application Publication
(10) Pub. No.: US 2001/0052277 A1
(43) Pub. Date: Dec. 20, 2001

(54) Cutting machine and method for using vented pneumatic cylinder

(76) Inventors: John Henry Giovanni, Brockton, MA (US); Christopher M. Cabana, South Easton, MA (US)

Correspondence Address: PERKINS, SMITH & COHEN LLP, ONE BEACON STREET, 30TH FLOOR, BOSTON, MA, 02108, US

(21) Appl. No.: 09/864,961

(22) Filed: May 24, 2001

Related U.S. Application Data
(60) Provisional application No. 60/209,912, filed on Jun. 7, 2000.

(51) Int. Cl. B26D 5/12

(52) U.S. Cl. 83/13; 83/639.1

(57) ABSTRACT

Method and apparatus for producing holes, slits, cuts or the like in flexible materials such as films of polyethylene, polypropylene, laminates and coextrusions with reduced noise using a controlled pulse of compressed air to activate a vented pneumatic cylinder which incorporates the cutting element into the cylinder by integrating it into the plunger. The unit is activated by pulsing an electric solenoid valve controlling a supply of compressed air of a known pressure to move the plunger/cutting tool. The body of the pneumatic cylinder is vented at a known position relative to the overall stroke of the plunger to relieve the pressure without an exhaust at the driving air admission end. This allows control of the plunger stroke to pass the cutting tool through the material to be cut without having to physically restrict the length of plunger stroke. Because the stroke is controlled in this manner, the plunger start and stop position can be maintained without physical contact with the ends of the cylinder body. This eliminates the noise ordinarily associated with these types of systems.

### CROSS REFERENCE TO RELATED APPLICATIONS

This application claims priority of the U.S. Provisional Application Ser. No. 60/209,912 filed Jun. 7, 2000 entitled CUTTING MACHINE USING VENTED PNEUMATIC CYLINDER TO REDUCE NOISE AND IMPROVE SAFETY.

### FIELD OF THE INVENTION

This invention relates generally to an improved method and apparatus for producing holes, slits, and cuts in flexible materials, and more particularly to an improved method and apparatus for producing holes, slits, cuts or the like in flexible materials using compressed air to activate a vented pneumatic cylinder.

### BACKGROUND

Plastic bags, packages and film require slits, cuts and/or holes in them for a variety of reasons and purposes. In the bag industry, shaped holes are used for carry handles and for hanging of bags in store displays. In the packaging industry, automatic bag-filling machines, such as those used in bread packaging, require bags to be placed on wickets. In order to place a bag on a wicket, two holes are needed at the lip of the bag. These holes, commonly referred to as wicket holes, have a slit or serration above them to make sure the bag tears off the wicket when filled. In the food packaging industry, bags and packaging with multiple rows of round holes are required to vent the bags for fruits and vegetables such as apples, potatoes, and the like. These holes allow for the exchange of gases and the release of moisture to prevent the product from rotting.

In the early days, it was common for a bag producer to use a hand drill and drill through the rolls of polyethylene material prior to its conversion into bags. This process was inefficient as well as inconsistent since the closer to the roll core the drill came, the closer the holes came to each other.

This method eventually gave way to cutting the required holes in each bag as the bags were being produced on the bag making machine. The units that were developed used compressed air to close a cylinder in cycle with the bag making process. The cutting tool was attached to a pneumatic cylinder rod. Eventually multiple hole units were developed where two or three cylinders were used to move a plate or bar that held the multiple cutting tools.

The problem with these types of machines is they usually have exposed moving parts that can create a safety issue when improperly used. In addition, pneumatic cylinders cycling at high speeds tend to be very noisy, both from the contact noise of the piston hitting the ends of the cylinder body and from the noise of the pressure exhaust at the end of the cutting cycle. Thus, a main source of noise in the bag making process comes from the punching equipment with their pneumatic cylinders. These kinds of machines also experience excessive downtime for maintenance of worn or broken parts due to the cycling and vibration of the units.

### SUMMARY OF THE INVENTION

It is an object, therefore, of the present invention to improve the safety conditions, noise level, and uptime performance of machines used for producing holes, slits, and cuts in flexible materials. In the embodiment set forth herein, a cutting machine uses a controlled pulse of compressed air to activate a vented pneumatic cylinder which incorporates a cutting element into the cylinder by integrating the cutting element into the plunger or piston. The unit is activated by pulsing an electric solenoid valve supplying compressed air of a known pressure to move the punch assembly. This new concept addresses the main problems generated by the traditional pneumatic cylinder with cutting tool attached concept.

A key aspect of the invention is the punch assembly is free floating within the pneumatic cylinder body. In other words, the outermost surface of the punch assembly, called a plunger, is not maintained in an airtight configuration with the body of the cylinder. The punch assembly travels upward and downward freely within the cylinder body along alignment rods to insure the assembly does not rotate during operation.

Another key aspect of the invention is the opening in the pneumatic cylinder body which allows the pressurized air to be expelled without an exhaust after completion of a cutting stroke. The opening in the cylinder body is located approximately at the same vertical position as the uppermost part of the plunger when the punch assembly is at the end of its downward, cutting stroke. This feature allows the plunger stroke to be controlled as the cutting tool passes through the material to be cut without having to physically restrict the length of the plunger stroke. Because the stroke is controlled in this manner, the plunger start and stop position can be maintained without physical contact with the ends of the cylinder body. This eliminates the contact noise ordinarily associated with traditional pneumatic cylinder with cutting tool attached systems.

Since an airtight seal is no longer required, the plunger is manufactured from a plastic material, creating a much lighter weight punch assembly. This reduced weight allows the pneumatic cylinder to run at substantially lower air pressures compared to similar systems. This reduced weight also permits the spring force needed to retract the punch assembly back into the cylinder body to be less. The vented pneumatic cylinder concept also eliminates the noise of the pressure exhaust at the end of the cutting cycle associated with traditional systems.

Another key aspect of the invention is the cutting tools are attached directly to the plunger and incorporated into the body of the pneumatic cylinder. This feature provides for improved operator safety conditions since the sharp end of the tool is only exposed during the cutting process. By design, these types of cutting tools must be sharp. These sharp tools represent a potential point of injury for an operator or bystander. The unit is designed to restrict access between the cutting tool and the die eliminating the chance of accidental injury.

This invention also affords increased uptime of the cutting machine by improving its serviceability. By nature, the plastic materials that are being cut are abrasive and the cutting tools used are frequently being worn, requiring occasional replacement. This cutting machine is designed so that the cutters can be changed without the use of tools. This reduces downtime to a minimum.

It is possible to apply the vented cylinder concept to other cutting applications where noise reduction, improved safety, and increased uptime are desired. For example, two or three of these types of cylinders could be attached to a single bar or plate to which are attached multiple cutting assemblies. Multiple vented cylinders with plunger/cutting tool combinations could be applied to a variety of applications. The cylinder assembly can be manufactured for use with a variety of shaped hole cutters applying it to multiple applications, primarily in the field of plastic packaging and converting.

Other aspects of the present invention will become more fully apparent from the following detailed description of the preferred embodiments, the accompanying drawings and the appended claims.

### BRIEF DESCRIPTION OF THE DRAWINGS

FIG. 1 is a front view of the cutting machine with a vented pneumatic cylinder;

FIG. 2 is a left side view of the cutting machine with a vented pneumatic cylinder;

FIG. 3 is a top view of the cutting machine with a vented pneumatic cylinder;

FIG. 4 is a left side view of the punch assembly;

FIG. 5 is a back view of the punch assembly; and

FIG. 6 is a bottom view of the punch assembly.

### Description of Preferred Embodiments

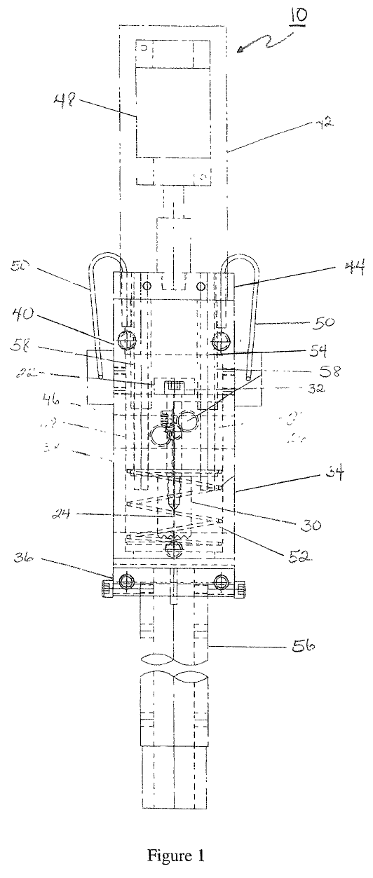

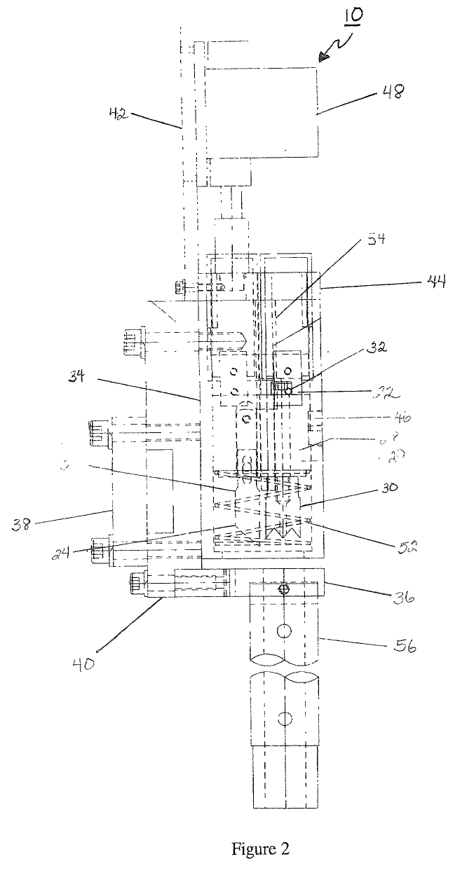

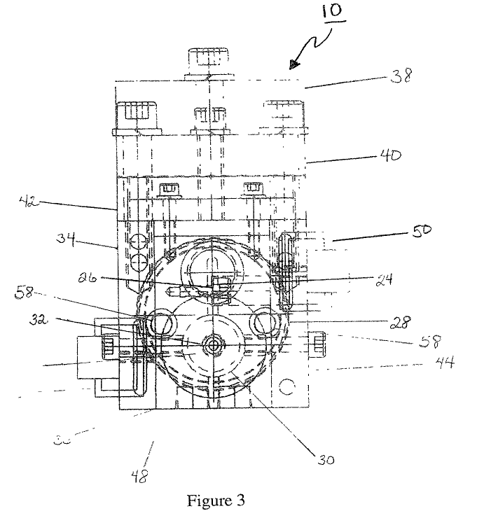

In brief overview and referring to FIGS. 1-3, a cutting machine using a vented pneumatic cylinder 10 of the present invention includes a pneumatic cylinder body 34, an opening 46 located in the pneumatic cylinder body 34, a punch assembly 20 traveling substantially upward and downward within the cylinder body 34, alignment rods 58 located within the cylinder body 34 upon which the punch assembly 20 travels substantially upward and downward, a solenoid valve 48 supplying compressed air to the upper portion of the cylinder body 34 above the punch assembly 20, a spring 52 located in the lower portion of the cylinder body 34 beneath the punch assembly 20 which maintains the punch assembly 20 within the cylinder body 34, and a bumper 54 located in the upper portion of the cylinder body 34 above the punch assembly 20 which serves as a stopper during the substantially upward motion of the punch assembly 20.

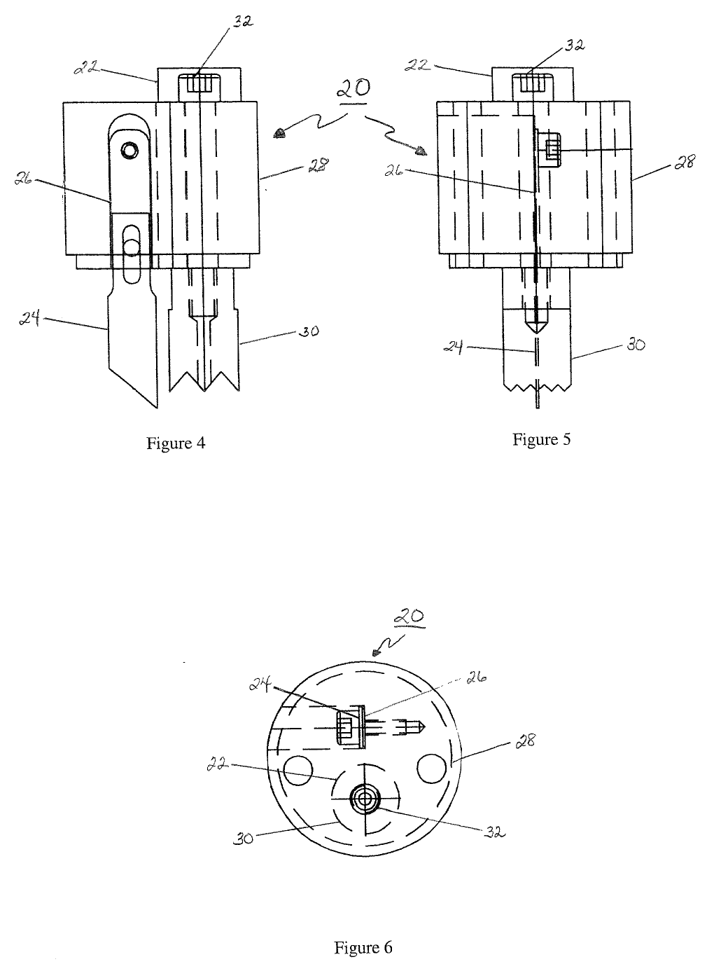

In more detail and referring also to FIGS. 4-6, the punch assembly 20 includes a handle 22 located at the top of the punch assembly 20, a punch 30 located in the front portion of the punch assembly 20, which cuts the flexible material with its sharp, lower section, a slit blade 24 located in the back portion of the punch assembly 20 behind the punch 30 which cuts the flexible material with its sharp, lower edge, a blade tab 26 located above the slit blade 24 which holds the slit blade 24 into place and allows for a toolless change of the slit blade 24, a plunger 28 which constitutes the outermost surface of the punch assembly 20 and is in communication with the cylinder body 34, and a blow through screw 32 located in the center portion of the punch 30. The outer surface of the plunger 28 is not maintained in an airtight configuration with the inner surface of the cylinder body 34 and is thus, free floating. Both the cutting tools, the slit blade 24 and the punch 30, are directly attached to the plunger 28.

In addition, the lower portion of the cutting machine 10 includes a die plate 36 located beneath the cylinder body 34 along which the flexible material to be cut is placed and a slug tube 56 located beneath the die plate 36 and the punch 30 where the cut out piece of flexible material, called a slug, is received. The rear portion of the cutting machine 10 includes a mounting plate 40 attached to which are the cylinder body 34, the die plate 36, and a solenoid valve plate 42. A clamping plate 38, located behind the mounting plate 40, secures the mounting plate 40 to the cylinder body 34. Attached to the solenoid valve plate 42 is a cylinder body cover 44 located directly above the cylinder body 34 and a solenoid valve 48 located above the cylinder body 34. Attached to the cylinder body cover 44 are the alignment rods 58 and two toggle latches 50 located on either side of the cylinder body 34 which fasten the cylinder body cover 44 to the top portion of the cylinder body 34.

During a typical cutting cycle, the cutting machine 10 is activated by pulsing an electric solenoid valve 48 supplying compressed air of a known pressure to the upper portion of the cylinder body 34 above the punch assembly 20. Various pressures may be used depending on the desired speed of punch assembly 20, though pressures as low as 15-20 psi have successfully been used. When the compressed air is released to the upper portion of the cylinder body 34, the punch assembly 20 begins to move substantially downward within the cylinder body 34. The punch assembly 20 travels along the alignment rods 58 to insure the assembly 20 does not rotate during operation. As the punch assembly 20 continues downward, the cutting tools 24, 30 proceed out of the lower end of the cylinder body 34 and through the flexible material positioned on the die plate 36.

Towards the end of the downward, cutting stroke, the opening 46 in the cylinder body 34 becomes exposed to the pressurized air and the air is substantially expelled. The spring 52, which became compressed during the downward motion of the punch assembly 20, pushes the cutting tools 24, 30 back into the cylinder body 34 as the punch assembly 20 moves substantially upward. The opening 46 in the cylinder body 34 may be of various shapes and sizes depending on the desired slowdown of the punch assembly's 20 downward motion and the desired speed of the punch assembly's upward retraction. Preferably, the opening 46 is an oblong slot in the cylinder body 34. Although the opening 46 is shown in the front portion of the cylinder body 34 in FIGS. 1-3, other horizontal positions around the cylinder body 34 may be utilized. In one embodiment, the cutting machine 10 uses only one vented pneumatic cylinder. In another embodiment, multiple vented pneumatic cylinders may be utilized.

Venting the cylinder body 34 at the end of the cutting stroke enables the punch assembly 20 to stop without contacting the end of the cylinder body 34, thereby eliminating the contact noise. At the completion of the cutting cycle or during the upward motion of the punch assembly 20, a rubber stop or bumper 54 further reduces the noise and vibration of the cutting machine 10.

During operation, the cutting tools 24, 30 are replaced by releasing the two toggle latches 50 and removing the cylinder body cover 44. The alignment rods 58 with caps at the ends are attached to the cylinder body cover 44 and allow the entire punch assembly 20 to be easily removed and serviced.

It is to be understood that the above-described embodiments are simply illustrative of the principles of the invention. Various and other modifications, changes, details and uses may be made by those skilled in the art which will embody the principles of the invention and fall within the spirit and scope of the appended claims.

What is claimed is:

1. An apparatus for producing perforations in a flexible material comprising:
a pneumatic cylinder body having a first portion and a second portion;
an opening located in said pneumatic cylinder body;
alignment rods located within said pneumatic cylinder body;
a punch assembly which freely moves substantially linearly within said pneumatic cylinder body along said alignment rods;
means for supplying compressed air to the first portion of said pneumatic cylinder body; and
a spring located in the second portion of said pneumatic cylinder body adjacent to said punch assembly which maintains said punch assembly within said pneumatic cylinder body.

2. The apparatus of claim 1 wherein said punch assembly further comprises a cutting means and a plunger, said plunger in communication with said pneumatic cylinder body.

3. The apparatus of claim 2 wherein said cutting means is a punch and/or a slit blade.

4. The apparatus of claim 3 wherein said slit blade further comprises a blade tab located adjacent said slit blade which holds said slit blade into place.

5. The apparatus of claim 2 wherein said cutting means is directly attached to said plunger.

6. The apparatus of claim 2 wherein said plunger is made of a plastic material.

7. The apparatus of claim 1 wherein said opening is an oblong slot.

8. The apparatus of claim 1 further comprising a bumper located in the first portion of said pneumatic cylinder body adjacent said punch assembly.

9. The apparatus of claim 1 further comprising a cylinder body cover attached to said alignment rods, said pneumatic cylinder body cover located adjacent said pneumatic cylinder body and fastened to the first portion of said pneumatic cylinder body.

10. An apparatus for producing perforations in a flexible material comprising:
a frame; and
a plurality of vented pneumatic cylinder assemblies attached to said frame wherein a vented pneumatic cylinder assembly comprises a pneumatic cylinder body having a first portion and a second portion, an opening located in said pneumatic cylinder body, alignment rods located within said pneumatic cylinder body, a punch assembly which freely moves substantially linearly within said pneumatic cylinder body along said alignment rods, means for supplying compressed air to the first portion of said pneumatic cylinder body, and a spring located in the second portion of said pneumatic cylinder body adjacent to said punch assembly to maintain said punch assembly within said pneumatic cylinder body.

11. The apparatus of claim 10 wherein said punch assembly further comprises a cutting means and a plunger, said plunger in communication with said pneumatic cylinder body.

12. The apparatus of claim 11 wherein said cutting means is a punch and/or a slit blade.

13. The apparatus of claim 12 wherein said slit blade further comprises a blade tab located adjacent said slit blade which holds said slit blade into place.

14. The apparatus of claim 11 wherein said cutting means is directly attached to said plunger.

15. The apparatus of claim 11 wherein said plunger is made of a plastic material.

16. The apparatus of claim 10 wherein said opening is an oblong slot.

17. The apparatus of claim 10 wherein said vented cylinder assembly further comprises a bumper located in the first portion of said cylinder body adjacent said punch assembly.

18. The apparatus of claim 10 wherein said vented cylinder assembly further comprises a cylinder body cover attached to said alignment rods, said pneumatic cylinder body cover located adjacent said pneumatic cylinder body and fastened to the first portion of said pneumatic cylinder body.

19. The apparatus of claim 10 wherein said frame is a bar or a plate.

20. A method of producing perforations in a flexible material comprising:
placing the flexible material in the path of a fluid drivable hollow body;
supplying compressed gas of a known pressure to a drive portion of said body;
moving a punch assembly substantially downward within said body along alignment rods;
extending said punch assembly below a lower portion of said body;
cutting the flexible material with said punch assembly;
exposing an opening in said body to the compressed gas in said body;
venting a substantial amount of the compressed gas from said body through said opening; and
retracting said punch assembly by moving said punch assembly substantially upward within said body.
